(19) United States
(12) Patent Application Publication
(10) Pub. No.: US 2019/0263708 A1
(43) Pub. Date: Aug. 29, 2019

(54) METHODS FOR MANUFACTURING THREE-DIMENSIONAL LAMINATE GLASS ARTICLES

(71) Applicant: CORNING INCORPORATED, CORNING, NY (US)

(72) Inventors: Dana Craig Bookbinder, Corning, NY (US); David Alan Deneka, Corning, NY (US); Paul Bennett Dohn, Corning, NY (US); Paul Oakley Johnson, Corning, NY (US); William Edward Lock, Horseheads, NY (US); David John McEnroe, Corning, NY (US); Pushkar Tandon, Painted Post, NY (US); Natesan Venkataraman, Painted Post, NY (US); Sam Samer Zoubi, Horseheads, NY (US)

(21) Appl. No.: 16/307,797

(22) PCT Filed: Jun. 6, 2017
(86) PCT No.: PCT/US2017/036137

§ 371 Date: Dec. 6, 2018

Related U.S. Application Data
(60) Provisional application No. 62/346,834, filed on Jun. 7, 2016.

(51) Int. Cl. C03B 23/203; C03B 23/03; C03B 23/025

(52) U.S. Cl. CPC C03B 23/203; C03B 23/0307; C03B 2215/406; C03B 2215/44; C03B 23/0258

(57) ABSTRACT

According to one or more embodiments described herein, a three-dimensional laminate glass article may be manufactured by a process which may include heating a glass stack including at least two glass sheets that are unbonded with one another at a first temperature range, fusing the first glass sheet with the second glass sheet by heating the glass stack at a second temperature range, and shaping the glass stack. The first temperature range may be from about 150° C. to about 400° C. for a first period of time of at least about 5 minutes. The second temperature range may be from about 400° C. to about 1200° C.

This application claims the benefit of priority to U.S. Application No. 62/346,834, filed Jun. 7, 2016, the content of which is incorporated herein by reference in its entirety.

### BACKGROUND

### Field

The present specification generally relates to methods for producing glass articles and, more specifically, to methods for producing laminate glass articles comprising at least two glass layers bonded with one another.

### Technical Background

Glass articles, such as cover glasses, glass backplanes, and the like, are employed in both consumer and commercial electronic devices such as LCD and LED displays, computer monitors, automated teller machines (ATMs), and such. Some of these glass articles may include “touch” functionality, which necessitates that the glass article be contacted by various objects including a user's fingers and/or stylus devices and, as such, the glass must be sufficiently robust to endure regular contact without damage. Moreover, such glass articles may also be incorporated in portable electronic devices, such as mobile telephones, personal media players, and tablet computers. The glass articles incorporated in these devices may be susceptible to damage during transport and/or use of the associated device. Accordingly, glass articles used in electronic devices may require enhanced strength to be able to withstand not only routine “touch” contact from actual use, but also incidental contact and impacts that may occur when the device is being transported.

Various processes may be used to strengthen glass articles, including chemical tempering, thermal tempering, and lamination. A glass article strengthened by lamination is formed from at least two glass compositions that have different coefficients of thermal expansion. These glass compositions may be brought into contact with one another at high temperatures to form the glass article and fuse or laminate the glass compositions together. As the glass compositions cool, the difference in the coefficients of thermal expansion cause compressive stresses to develop in at least one of the layers of glass, thereby strengthening the glass article. Lamination processes can also be used to impart or enhance other properties of laminate glass articles, including physical, optical, and chemical properties.

However, laminate glass sheets may have complicated and expensive fabrication processes involving melting the glass compositions to a molten state and down-drawing the compositions to form the laminate. Additionally, glasses that have different viscosities at the forming temperature may not be able to be paired in a laminate by a down-draw process. Accordingly, a need exists for alternative method for producing laminate glass articles.

### SUMMARY

Embodiments described herein include methods for manufacturing three-dimensional laminate glass articles. According to one embodiment, a three-dimensional laminate glass article may be manufactured by a process which may include heating a glass stack comprising at least a first glass sheet and a second glass sheet that are unbonded with one another. The glass stack may be heated at a first temperature range of from about 150° C. to about 400° C. for a first period of time of at least about 5 minutes. The glass stack may then be fused by heating the glass stack at a second temperature range of from about 400° C. to about 1200° C. The glass stack may also be shaped to form a three-dimensional laminate glass article.

According to another embodiment, the above-described shaping of the glass stack may encapsulate the second glass sheet inside a cladding comprising the first glass sheet and the third glass sheet. For example, in one embodiment, the shaping may comprise contacting an outer perimeter of the glass stack with a ring of a mold assembly, allowing at least a portion of the glass stack to sag to form a three-dimensional shape, and encapsulating the second glass sheet inside a cladding comprising the first glass sheet and the third glass sheet with the ring. In another embodiment, the shaping may comprise contacting a first outer surface of the glass stack with a mold body of a mold assembly, contacting a second outer surface of the glass stack opposite the first outer surface with a plunger of the mold assembly in a direction generally orthogonal to a molding surface of the mold assembly, and pushing an outer perimeter of the glass stack into a ring of the mold assembly to encapsulate the second glass sheet inside the cladding comprising the first glass sheet and the third glass sheet. In another embodiment, shaping may comprise encapsulating the second glass sheet inside the cladding comprising the first glass sheet and the third glass sheet by contacting the glass sheet with angled jaws that press into the glass stack.

Embodiments described herein include methods for manufacturing three-dimensional laminate glass articles. According to one embodiment, a three-dimensional laminate glass article may be manufactured by a process which may include heating a glass stack comprising at least a first glass sheet, a second glass sheet, and a third glass sheet that are unbonded with one another. The glass stack may be heated at a first temperature range of from about 150° C. to about 400° C. for a first period of time of at least about 5 minutes. The glass stack may then be fused by heating the glass stack at a second temperature range of from about 400° C. to about 1200° C. The glass stack may also be shaped to form a three-dimensional laminate glass article. The second glass sheet may be positioned between the first glass sheet and the third glass sheet. The first glass sheet may exhibit a first coefficient of thermal expansion (CTE) and a first viscosity, the second glass sheet may exhibit a second CTE and a second viscosity, and the third glass sheet may exhibit a third CTE and a third viscosity. The second CTE may be greater than the first CTE and the third CTE, and the second viscosity may be less than the first viscosity and the third viscosity.

Additional features and advantages of the methods described herein will be set forth in the detailed description that follows, and in part will be readily apparent to those skilled in the art from that description or recognized by practicing the embodiments described herein, including the detailed description that follows, the claims, as well as the appended drawings. It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a method for manufacturing laminate glass articles, according to one or more embodiments shown and described herein;

FIG. 2 schematically depicts a method for manufacturing three-dimensional laminate glass articles, according to one or more embodiments shown and described herein;

FIG. 3 schematically depicts a method for manufacturing three-dimensional laminate glass articles, according to one or more embodiments shown and described herein;

FIG. 4 schematically depicts a method for manufacturing three-dimensional laminate glass articles using a molding assembly, according to one or more embodiments shown and described herein;

FIG. 5 schematically depicts a method for manufacturing three-dimensional laminate glass articles using a shearing assembly, according to one or more embodiments shown and described herein;

FIG. 6A depicts a three-dimensional laminate glass article, according to one or more embodiments shown and described herein; and

FIG. 6B depicts another view of the three-dimensional laminate glass article of FIG. 5A, according to one or more embodiments shown and described herein.

### DETAILED DESCRIPTION

Reference will now be made in detail to embodiments and methods for producing three-dimensional laminate glass articles, examples of which are illustrated in the accompanying drawings. Whenever possible, the same reference numerals will be used throughout the drawings to refer to the same or like parts.

Generally described herein are methods for manufacturing laminate glass articles and, in some embodiments, manufacturing three-dimensional laminate glass articles. Generally, the laminate glass articles may be formed from glass stacks, which include two or more glass sheets. The glass stacks may be heated to an elevated temperature to fuse the glass sheets with one another, forming laminate glass articles. In some embodiments, the glass sheets may be fused together at the same time that they are shaped. In other embodiments, a substantially flat laminate glass article (i.e., two-dimensional in shape) made up of the fused sheets may be shaped into a three-dimensional article in a separate step from the fusing. According to one or more embodiments, before the glass layers are fused with one another to form the laminate glass article, the glass layers may be subjected to a heat treatment in the presence of humidity to form a relatively weak bond, such as a hydrogen bond, between the glass sheets of the glass stack. While the weak bonds are not permanent bonds, such as those created through the fusion of two or more glass sheets, the weak bond may serve to stabilize the glass sheets in a desired position relative to one another during subsequent processing steps, such as handling and/or fusing. For example, the glass sheets may be aligned with one another in a desired configuration, subjected to a heat treatment to form the weak bond, and then handled prior to fusing. The glass sheets which are weakly bonded with one another may not inadvertently change position relative to one another during the handling prior to the fusing of the glass sheets. For example, a glass sheets may be cleaned and assembled into a glass stack under specialized conditions, such as in a clean room, subsequently handled, and fused in another area. The glass sheets that are weakly bonded may be more secure in transportation from the assembly area to the fusing area.

In one or more embodiments, the shaping may be performed by using a mold assembly. The mold assembly may comprise a mold body, a ring, and/or a plunger. During shaping with the mold assembly, the glass stack may be pressed down into a mold body at elevated temperatures, which may force the outer perimeter of the glass stack into the ring to form rounded edges on the three-dimensional laminate glass article. In some embodiments, the laminate glass article is layered so that when the glass stack is forced into the ring, the innermost layer of the glass stack may become encapsulated by the outer layers upon shaping to provide strength and reinforcement. With such a process, a strengthened glass article can be produced by CTE mismatch in the fused layers. Moreover, if the glass sheet is weakly bonded prior to the shaping process, the shaping by the mold assembly may serve to fuse the glass sheets with one another while the shaping occurs, with minimal unwanted shifting of the glass sheets prior to shaping/fusing in the mold assembly. In some embodiments, a ring of the mold assembly may be used to shape the article, by allowing the glass stack to sag into a lower portion in the ring mold through the use of gravity and, in some embodiments, heat, while the glass stack is pressed into an upper portion of the ring mold to encapsulate a core layer comprising the second glass sheet with a cladding layer comprising the first glass sheet and the third glass sheet to provide strengthened edges in the three-dimensional laminate glass article. Alternatively, angled jaws may be used to shear the laminate glass article to encapsulate a core layer comprising the second glass sheet with a cladding layer comprising the first glass sheet and the third glass sheet to provide strengthened edges in the three-dimensional laminate glass article.

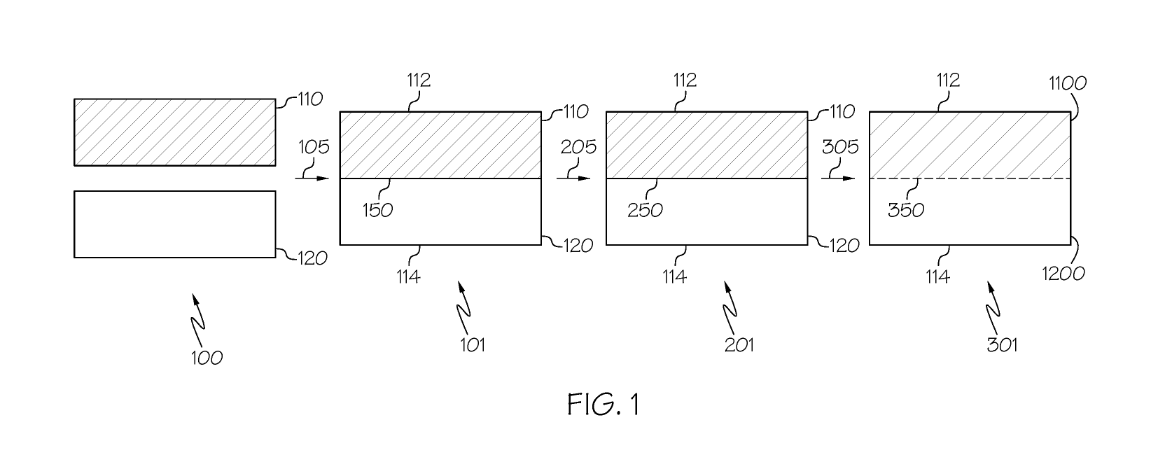

Specific embodiments will now be described with reference to FIGS. 1, 2, 3, 4, 5A, and 5B. Referring now to FIG. 1, a method for manufacturing a laminate glass article according to one or more embodiments shown and described herein is schematically depicted. In FIG. 1, the components of an unassembled glass stack 100 are provided, which may comprise a first glass sheet 110 and a second glass sheet 120. In some embodiments, the unassembled glass stack 100 may undergo an assembly step 105 to form an unbonded glass stack 101. In the assembly step 105, the glass sheets 110 and 120 are aligned relative to one another such that their surfaces, which will be fusion bonded to one another, may be in direct contact. In other embodiments, the first glass sheet 110 and the second glass sheet 120 may be adjacent one another, but not in direct contact. For example, in some embodiments, a glass or non-glass bonding material may be placed between the first glass sheet 110 and the second glass sheet 120. In some embodiments, adhesives, spacing materials, or other glass or non-glass sheets may be positioned between the first glass sheet 110 and the second glass sheet 120. While the unbonded glass stack 101 in FIG. 1 comprises a first glass sheet 110 and a second glass sheet 120, it should be understood that the unbonded glass stack 101 may comprise any number of glass sheets. For example, in some embodiments the unbonded glass stack 101 may comprise three glass sheets. In other embodiments, the unbonded glass stack 101 may comprise four glass sheets, five glass sheets, six glass sheets, seven glass sheets, eight glass sheets, nine glass sheets, ten glass sheets, or more than ten glass sheets aligned with one another to form the unbonded glass stack 101. In embodiments comprising three or more glass sheets, an interior glass sheet may be referred to sometimes herein as a core glass sheet or layer, and glass sheets which at least partially surround the core glass sheet may be referred to herein as cladding glass sheets or layers. Sometimes, the collection of glass sheets that surrounds the core glass sheet is referred to as the cladding. For example, in a three layer embodiments, the outer layers may be referred to as the cladding and the inner layer may be referred to as the core.

In one or more embodiments, the first glass sheet 110 and the second glass sheet 120 may comprise different compositions. In an embodiment where the first glass sheet 110 and the second glass sheet 120 have different compositions, they may have different temperatures corresponding to key viscosity points, such as softening point. In some embodiments, the material of the first glass sheet 110 and the material of the second glass sheet 120 may have a difference in softening points of at least about 10^{7.6} poise, at least about 10⁹ poise, or even at least about 10¹⁰ poise. In some embodiments, the material of the first glass sheet 110 and the material of the second glass sheet 120 may have a difference in temperature at softening point of at least about 80° C. In other embodiments, the difference in temperature at softening point of the material of the first glass sheet 110 and the material of the second glass sheet 120 may be at least about 150° C., at least about 200° C. or even at least about 250° C.

Similarly, the material of the first glass sheet 110 and the material of the second glass sheet 120 may have different temperatures corresponding to the other important forming ranges, such as viscosity points, such as 10⁹ poise and 10¹⁰ poise. In some embodiments, the difference in temperature at these other key viscosity points (such as 10⁹ poise and 10¹⁰ poise) of the material of the first glass sheet 110 and the material of the second glass sheet 120 may be at least about 80° C. In other embodiments, the difference in temperature at these other key viscosity points of the material of the first glass sheet 110 and the material of the second glass sheet 120 may be at least about 150° C., at least about 200° C., or even at least about 250° C. In some embodiments, the viscosity of the outermost glass sheet (i.e., a glass sheet that forms a surface 112, 114 of a glass stack) may have a higher viscosity than the viscosity of the innermost glass sheet. For example, the viscosity of the outermost glass sheet may have a higher viscosity than the innermost glass sheet at a forming temperature (e.g., a first temperature within a first temperature range, or over the first temperature range, and/or a second temperature within a second temperature range, or over the second temperature range, as described herein) and/or at a key viscosity point (e.g., the softening point) of one of the outermost glass sheet or the innermost glass sheet. Without being bound by theory, the difference in viscosity may be beneficial to shaping and, for instance, may cause less glass marking and better dimensional uniformity in some embodiments.

In some embodiments, the glass sheets, such as the first glass sheet 110 and the second glass sheet 120, may be characterized by a thickness, a length, and a width, wherein thickness is the smallest dimension and length is the largest dimension. In some embodiments, each of the width and the length may be at least 10 times, at least 100 times, or at least 1000 times the thickness of the glass sheets such as the first glass sheet 110 and the second glass sheet 120.

In some embodiments, the thickness of the first glass sheet 110 can be, for example, ≤5 mm. In embodiments, the thickness of the first glass sheet 110 can be, for example, ≤2 mm. In embodiments, the thickness of the first glass sheet 110 can be, for example, ≤1 mm. In embodiments, the thickness of the first glass sheet 110 can be, for example, ≤0.5 mm. In embodiments, the thickness of the first glass sheet 110 can be, for example, ≤0.1 mm. In embodiments, the thickness of the first glass sheet 110 can be, for example, ≤5 mm and ≥0.05 mm. In embodiments, the thickness of the first glass sheet 110 can be, for example, ≤2 mm and ≥0.05 mm. In embodiments, the thickness of the first glass sheet 110 can be, for example, ≤1 mm and ≥0.05 mm.

In some embodiments, the thickness of the second glass sheet 120 can be, for example, ≤5 mm. In embodiments, the thickness of the second glass sheet 120 can be, for example, ≤2 mm. In embodiments, the thickness of the second glass sheet 120 can be, for example, ≤1 mm. In embodiments, the thickness of the second glass sheet 120 can be, for example, ≤0.5 mm. In embodiments, the thickness of the second glass sheet 120 can be, for example, ≤0.1 mm. In embodiments, the thickness of the second glass sheet 120 can be, for example, ≤5 mm and ≥0.05 mm. In embodiments, the thickness of the second glass sheet 120 can be, for example, ≤2 mm and ≥0.05 mm. In embodiments, the thickness of the second glass sheet 120 can be, for example, ≤1 mm and ≥0.05 mm.

In one or more embodiments, the length and/or width of the first glass sheet 110 can be, for example, ≥50 mm. In embodiments, the length and/or width of the first glass sheet 110 can be, for example, ≥200 mm. In embodiments, the length and/or width of the first glass sheet 110 can be, for example, ≥1000 mm. In embodiments, the length and/or width of the first glass sheet 110 can be, for example, ≥50 mm and ≤3000 mm.

In some embodiments, the length and/or width of the second glass sheet 120 may be, for example, ≥50 mm. In embodiments, the length and/or width of the second glass sheet 120 can be, for example, ≥200 mm. In embodiments, the length and/or width of the second glass sheet 120 can be, for example, ≥1000 mm. In embodiments, the length and/or width of the second glass sheet 120 can be, for example, ≥50 mm and ≤3000 mm.

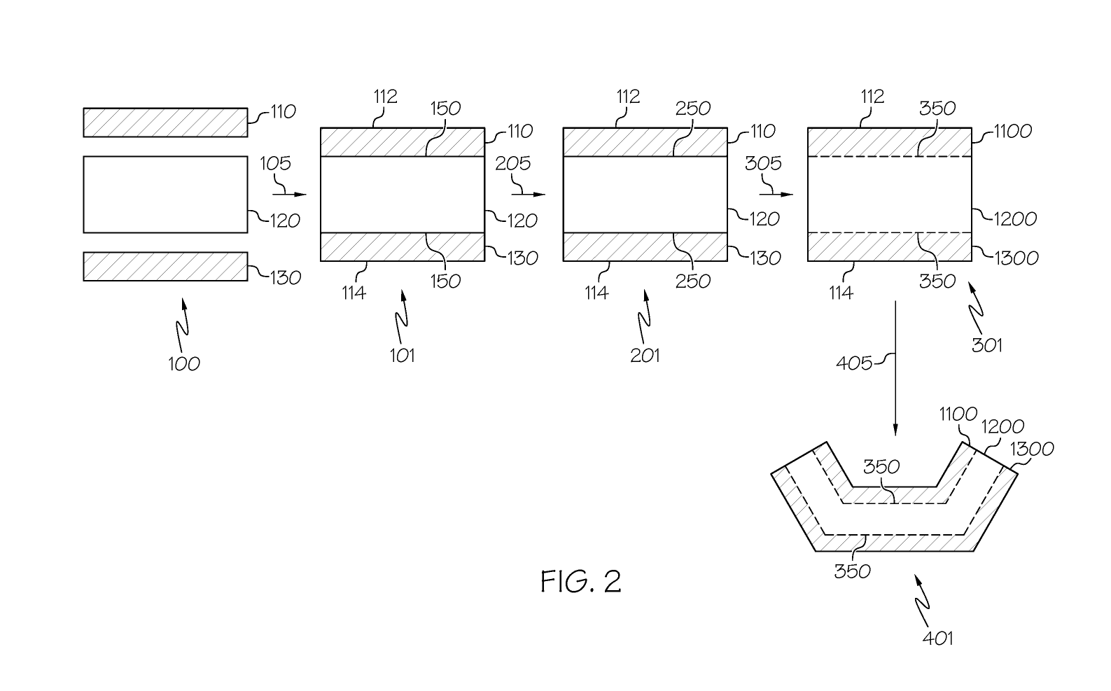

In embodiments which include a third glass sheet (such as shown in FIG. 2 and described herein), the thickness of the third glass sheet 130 can be, for example, ≤5 mm. In embodiments, the thickness of the third glass sheet 130 can be, for example, ≤2 mm. In embodiments, the thickness of the third glass sheet 130 can be, for example, ≤1 mm. In embodiments, the thickness of the third glass sheet 130 can be, for example, ≤0.5 mm. In embodiments, the thickness of the third glass sheet 130 can be, for example, ≤0.1 mm. In embodiments, the thickness of the third glass sheet 130 can be, for example, ≤5 mm and ≥0.05 mm. In embodiments, the thickness of the third glass sheet 130 can be, for example, ≤2 mm and ≥0.05 mm. In embodiments, the thickness of the third glass sheet 130 can be, for example, ≤1 mm and ≥0.05 mm. In some embodiments, the length and/or width of the third glass sheet 130 may be, for example, ≥50 mm. In embodiments, the length and/or width of the third glass sheet 130 can be, for example, ≥200 mm. In embodiments, the length and/or width of the third glass sheet 130 can be, for example, ≥1000 mm. In embodiments, the length and/or width of the third glass sheet 130 can be, for example, ≥50 mm and ≤3000 mm.

Referring again to FIG. 1, following the assembly step 105, an unbonded glass stack 101 is formed. It should be understood that an unbonded glass stack 101 may be provided by assembling one or more glass sheets such as the first glass sheet 110 and the second glass sheet 120. However, assembly of the glass stack is not required in providing the unbonded glass stack 101. For example, the unbonded glass stack 101 may be provided to a manufacturer in an as-assembled state. As used herein, the term “unbonded” refers to the state of a glass stack where two or more layers, such as two or more glass sheets, are not secured or attached to one another. The unbonded glass stack 101 may have a first surface 112 and a second surface 114 where the first surface 112 may be opposite of the second surface 114. In some embodiments, the first glass sheet 110 may be positioned in direct contact with the second glass sheet 120. As used herein, the phrase “direct contact” refers to physically touching without substantial obstruction, meaning that, in some embodiments, there are no adhesives or other non-glass layers positioned between the first glass sheet 110 and the second glass sheet 120.

Still referring to FIG. 1, the unbonded glass stack 101 may undergo a first heating step 205 at a first temperature range to form a weakly-bonded glass stack 201. In one or more embodiments, the first temperature range may be from about 150° C. to about 400° C. For example, the first temperature range may be from about 200° C. to about 350° C., or from about 250° C. to about 300° C. In one or more embodiments, the first temperature range of from about 200° C. to about 400° C., from about 250° C. to about 400° C., from about 300° C. to about 400° C., from about 350° C. to about 400° C., from 150° C. to about 350° C., from about 150° C. to about 300° C., from about 150° C. to about 250° C., or from about 150° C. to about 200° C. In some embodiments, the unbonded glass stack 101 may be heated at the first temperature range for a period of time of at least about 5 minutes. For example, the unbonded glass stack 101 may be heated for a period of time from about 5 minutes to about 3 hours. In some embodiments, the unbonded glass stack 101 may be heated for a period of time from about 5 minutes to about 1 hour, from about 5 minutes to about 2 hours, or from about 30 minutes to about 3 hours, from about 1 hour to about 3 hours, or from about 2 hour to about 3 hours. In some embodiments, the weakly-bonded glass stack 201 may be cooled to a temperature of less than about 100° C. after the heating at a first temperature range. The cooling may be active (such as by exposure to moving air or cold air), or may be passive in still ambient air. In one or more embodiments, the heating at a first temperature range may occur prior to the fusing of the glass stack.

In embodiments, the overall thickness of the weakly-bonded glass stack 210 can be, for example, ≤10 mm. In embodiments, the thickness of the weakly-bonded glass stack 210 can be, for example, ≤5 mm. In embodiments, the thickness of the weakly-bonded glass stack 210 can be, for example, ≤1 mm. In embodiments, the thickness of the weakly-bonded glass stack 210 can be, for example, ≥0.5 mm. In embodiments, the thickness of the weakly-bonded glass stack 210 can be, for example, ≤0.1 mm. In embodiments, the thickness of the weakly-bonded glass stack 210 can be, for example, ≤5 mm and ≥0.1 mm. In embodiments, the thickness of the weakly-bonded glass stack 210 can be, for example, ≤2 mm and ≥0.1 mm. In embodiments, the thickness of the weakly-bonded glass stack 210 can be, for example, ≤1 mm and ≥0.1 mm.

As mentioned herein, the first heating step 205 may form a weak bond between the first glass sheet 110 and the second glass sheet 120, which may secure the glass sheets together into the weakly-bonded glass stack 201. Like the unbonded glass stack 101, the weakly-bonded glass stack 201 has a first surface 112 and a second surface 114 and comprises the first glass sheet 110 and the second glass sheet 120; however, the first glass sheet 110 and the second glass sheet 120 now may have a weakly-bonded interface 250. As used herein, a “weak bond” or two layers that are “weakly-bonded” refers to a relatively weak bond or attraction between two or more glass sheets. As used herein, the term “interface” or “interfaces” refers to the boundary between one layer and another, such as the region between one glass sheet and another. In some embodiments, the weakly-bonded interface 250 may have hydrogen bonding between the first glass sheet 110 and the second glass sheet 120. As used herein, the term “hydrogen bond” refers to an electrostatic attraction between a hydrogen atom and an oxygen atom, usually between water or hydroxide molecules. In other embodiments, the weakly-bonded glass stack 201 may have a weakly-bonded interface 250 due to other attractive forces, including, but not limited to, Van Der Waals forces, covalent forces, ionic, or other intermolecular attractions. However, it should be understood that the weak bond is not permanent in nature, and the glass sheets 110, 120 that are weakly-bonded may be separated (as opposed to fused glass sheets, which are unitary following the fusing). In some embodiments, the weakly-bonded glass stack 201 may prevent the glass sheets 110, 120 from sliding relative to one another or otherwise moving during processing. The weakly-bonded glass stack 210 may also prevent contaminants from being introduced between the first glass sheet 110 and the second glass sheet 120 by reducing or, in some embodiments, removing a gap between the first glass sheet 110 and the second glass sheet 120.

In some embodiments, the first glass sheet 110 and the second glass sheet 120 may be assembled and/or heated to the first temperature under humidified conditions, which may provide moisture between the first glass sheet 110 and the second glass sheet 120 to form a hydrogen bond. One or more hydrogen molecules of waster may, in some embodiments, be attracted to an oxygen molecule present in the composition of the first glass sheet 110, the second glass sheet 120, or both. For example, in some embodiments, the composition of the first glass sheet 110, the second glass sheet 120, or both, may comprise silicon oxide (SiO₂) or aluminum oxide (Al₂O₃). Without being bond by theory, the polar negative charge of one or more oxygen atoms present in the glass composition of the first glass sheet 110 may be attracted to the polar positive charge of a hydrogen atom, such as from a water molecule. Likewise, one or more hydrogen atoms in the water, in turn, may be attracted to one or more oxygen atoms present in the second glass sheet 120, to form hydrogen bonds between the first glass sheet 110 and the second glass sheet 120. These hydrogen bonds may secure the first glass sheet 110 to the second glass sheet 120 to form the weakly-bonded glass stack 201.

Still referring to FIG. 1, weakly-bonded glass stack 201 may then undergo a fusing step 305 at a second temperature range (sometimes referred to herein as the fusing temperature) to form a laminate glass article 301. The term “laminate,” as used herein, refers to a glass stack comprised of two or more glass layers that are fused together. The heating at a second temperature range may fuse the first glass sheet 110 to the second glass sheet 120. As used herein, the term “fused” refers to a bond between glass layers (such as first glass layer 1100 and second glass layer 1200) formed by raising the material at least at the interface of the glass layers to a temperature sufficient to integrate the two glass layers into a single bonded article. The fusing step 305 may form a fused interface 350 between the first glass layer 1100 and the second glass layer 1200.

While the temperature for fusing glass may depend upon the compositions of the glass, suitable fusing temperatures utilized in step 305 may range from about 400° C. to about 1200° C. In one or more embodiments, the second temperature range for fusing may be from about 400° C. to about 1100° C., from about 400° C. to about 1000° C., or from about 400° C. to about 900° C., or from about 400° C. to about 800° C., or from about 400° C. to about 700° C. or from about 400° C. to about 600° C. or from about 400° C. to about 500° C. In additional embodiments, the second temperature range may be from about 500° C. to about 1200° C., from about 500° C. to about 1100° C., from about 500° C. to about 1000° C., or from about 500° C. to about 900° C., or from about 500° C. to about 800° C., or from about 500° C. to about 700° C., or from about 500° C. to about 600° C. In one or more embodiments, the second temperature range for fusing may be from about 600° C. to about 1100° C., from about 600° C. to about 1000° C., or from about 600° C. to about 900° C., or from about 600° C. to about 800° C., or from about 600° C. to about 700° C. or from about 700° C. to about 1200° C. or from about 700° C. to about 1100° C. or from about 700° C. to about 1000° C., from about 700° C. to about 900° C., or from about 700° C. to about 800° C., or from about 800° C. to about 1200° C., or from about 800° C. to about 1100° C. or from about 800° C. to about 1000° C. or from about 800° C. to about 900° C., or from about 900° C. to about 1200° C., or from about 900° C. to about 1100° C., or from about 900° C. to about 1000° C. The second temperature range utilized for fusing may vary depending on the softening point of the glasses utilized. For instance, softer glasses such as phosphates, borates, and fluorophosphates may need to be fused at a lower temperature, such as from about 800° C. to about 400° C., whereas harder glasses may need to be fused at a higher temperature such as from about 800° C. to about 1200° C. Without being bound by theory, a temperature below 400° C. may not properly fuse the glass sheets 110 and 120, and a temperature above 1200° C. may cause devitrification, a crystallization of the glass that may cause visual and/or structural defects.

For example, in one embodiment, the second temperature range utilized for fusing may be at least equal to the softening temperatures of the material of the glass sheet with the lowest softening point. In one or more embodiments, the second temperature range utilized for fusing may be less than the softening temperature of the material of the glass sheet with the lowest softening point, but within about 25° C., 50° C., 75° C., or 100° C. of the softening point of the material of the glass sheet with the lowest softening temperature.

While radiant heating may be employed in either of step 205 or step 305, other heating mechanisms are contemplated herein, such as convective heating and conductive heating. In some embodiments, the laminate glass article 301 may be cooled or allowed to cool to a temperature of less than about 100° C. after the fusing step 305.

In one or more embodiments, one or more of the first glass sheet 110 and second glass sheet 120 may be cleaned prior to the second heating step 305 at a second temperature range, such as prior to the first heating step 205 at a first temperature range, or prior to the assembly step 105. In some embodiments, one or more of the first glass sheet 110 and second glass sheet 120 may be provided with a fluorinated coating prior to heating to a first temperature range (such as prior to assembly step 105) in addition to, or in instead of, the cleaning. For example, in one or more embodiments, one or more of the surfaces of the first glass sheet 110 or second glass sheet 120 at the unbonded interface 150 may be chemically treated by a vacuum deposition process. In one or more embodiments, the vacuum deposition may be by plasma enhanced chemical vapor deposition (such as by a Applied Precision 5000 deposition apparatus, available from Applied Materials, Inc. of Santa Clara, Calif., USA). The vacuum deposition may deposit a fluorine-containing material, such as materials deposited from CF₄ and CHF₃ vapor deposition. Without being bound by theory, the fluorination process may affect the strength of the weak bond between the first glass sheet 110 and the second glass sheet 120, and may, in some embodiments, influence the final strength of the three-dimensional laminate glass article 401. In some embodiments, the coating may have a surface thickness of less than 1 μm. In some embodiments, a silane coupling agent may be used to improve adhesion of the first glass sheet 110 to the second glass sheet 120.

However, in other embodiments, a coating on the first glass sheet 110, the second glass sheet 120, or both, may be undesirable, as a coating may affect the chemistry at the weakly-bonded interface 250 of the glass sheets 110, 120. For instance, a coating component may, in some embodiments, diffuse into the glass during the fusing step 305, such as the diffusion of fluorine or hydrogen ions into the first glass sheet 110, the second glass sheet 120, or both. The glass stack may undergo fusing 305 under vacuum conditions to prevent unwanted contaminants from being introduced into the weakly-bonded glass stack 201 or the laminate glass article 301. In some embodiments, vacuum conditions may not be desired or necessary in forming the three-dimensional laminate glass articles 401, creating vacuum conditions may be time consuming and pose time and space limitations.

The fusing step 305 may form the first glass sheet 110 and the second glass sheet 120 into two fused glass layers, a first glass layer 1100 and a second glass layer 1200. Generally, the composition, thickness, CTE, and other properties of the first glass sheet 110 and the second glass sheet 120 may be about the same as those of the first glass layer 1100 and the second glass layer 1200. For example, the glass composition of each of the first glass layer 1100 and the second glass layer 1200 may be substantially identical to the glass composition of the first glass sheet 110 and the second glass sheet 120. For example, as used herein, “substantially identical” glass compositions refers to two or more glass compositions where each constituent of each glass composition being within about 5 wt. % of the other glass compositions. In one or more embodiments, the thickness of each of the first glass layer 1100 and the second glass layer 1200 may be about equal to the thickness of the first glass sheet 110 and the second glass sheet 120, respectively.

Referring now to FIG. 2, a method for manufacturing a three-dimensional laminate glass article 401 is schematically depicted. Like FIG. 1, the method shown in FIG. 2 includes an unassembled glass stack 100, which undergoes an assembly step 105 to form an unbonded glass stack 101, and may undergo a first heating step 205 at a first temperature range to form a weakly-bonded glass stack 201, and fusing the weakly-bonded glass stack 201 in step 305 to form a laminate glass article 301. The method depicted in FIG. 2 utilizes an additional shaping step 405 that shapes the laminate glass article 301 to form a three-dimensional laminate glass article 401.

The method depicted in FIG. 2 is depicted as including an unbonded glass stack 101 that has a third glass sheet 130 in addition to the first glass sheet 110 and the second glass sheet 120. The third glass sheet 130 may be in direct contact or adjacent to the second glass sheet 120. It should be understood that the methods depicted in any of FIGS. 1-4 may be utilized with any number of glass sheets or glass layers, as disclosed herein. In some embodiments, a glass stack that includes three glass sheets can form a strengthened glass laminate article, as described herein.

As shown in FIG. 2, the laminate glass article 301 may further undergo a shaping step 405. The shaping step 405 may comprise molding by processes such as molding, blowing, pressing, sagging, or otherwise forming the laminate glass article 301, or may involve any other suitable shaping methods known in the art. The shaping step 405 may produce the three-dimensional laminate glass article 401 from the laminate glass article 301. As used herein, a “three-dimensional” article 401 refers to an object having length, width, and depth beyond that of a flat plane. For example, glass sheets without additional geometric features are considered two-dimensional articles herein.

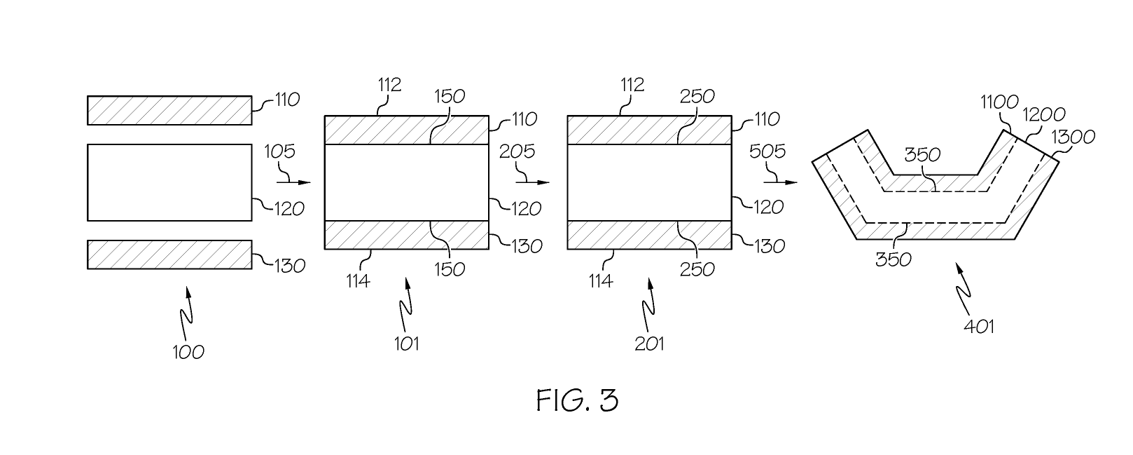

FIG. 3 depicts a method similar to the method of FIGS. 1 and 2, in which an unassembled glass stack 100 undergoes an assembly step 105 to form an unbonded glass stack 101 that undergoes a first heating step 205 at a first temperature range to form a weakly-bonded glass stack 201. As shown in FIG. 3, in some embodiments, the shaping step 405 may occur at the same times as the fusing step 305 in a simultaneous forming step 505. The simultaneous forming step 505 may include fusing the weakly-bonded glass stack 201 at the second temperature range, as discussed above, which may occur while molding, blowing, pressing, sagging, or otherwise forming the weakly-bonded glass stack 201. For example, the weakly-bonded glass stack 201 may be directly molded at the second temperature range, which fuses the components of the weakly-bonded glass sheets with one another. It should be understood that the existence of the weak bond may aid in positioning the glass stack in a mold while maintaining the positioning of the individual sheets of the weakly-bonded glass stack 201.

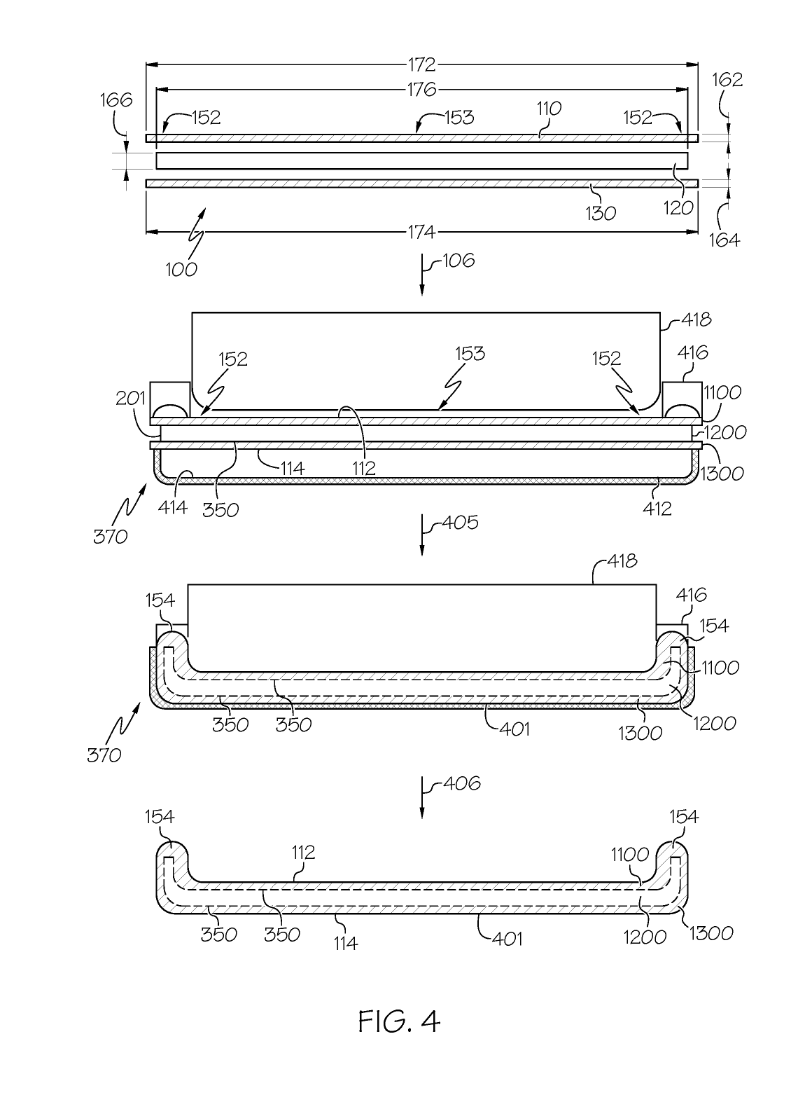

FIG. 4 schematically depicts a method for manufacturing a three-dimensional laminate glass article 401 utilizing a mold assembly 370. Like FIGS. 2 and 3, an unassembled glass stack 100 may be provided comprising a first glass sheet 110, a second glass sheet 120 and a third glass sheet 130. The first glass sheet 110 may have a length 172 and a thickness 162. Likewise, the second glass sheet 120 may have a length 176 and a thickness 166, and the third glass sheet 130 may have a length 174 and a thickness 164.

In some embodiments, the second glass sheet 120 (the interior glass sheet or core layer) may have a longitudinal length 176 that is less than the longitudinal length 172 of the first glass sheet 110 (an outer glass sheet or cladding layer) and the longitudinal length 174 of the third glass sheet 130 (another outer glass sheet or cladding layer). The unassembled glass stack 100 may have an outer perimeter 152 and an inner portion 153. The outer perimeter 152 may be an outer border or boundary of the unassembled glass stack 100, whereas the inner portion 153 may be comprised of the inner area of the unassembled glass stack 100. The unassembled glass stack 100 may undergo a processing step 106, which may, in some embodiments, comprise the assembly step 105 and first heating step 205 depicted by FIG. 1, in which the glass sheets 110, 120, 130 are assembled into an unbonded glass stack 101 and the unbonded glass stack 101 is heated to form a weakly-bonded glass stack 201.

Referring still to FIG. 4, the method may comprise a shaping step 405, wherein a mold assembly 370 (depicted in a cross-sectional view) comprises a mold body 412 including a molding surface 414, a ring 416, and a plunger 418. The mold body 412, ring, 416, and plunger 418 shape the weakly-bonded glass stack 201 (or, in some embodiments, a fused glass sheet) under heat. The mold assembly 370 may be utilized in shaping steps as disclosed with respect to the methods of FIG. 2 or FIG. 3. It should be understood that a wide variety of geometries of the mold body 412 may be used to form different three-dimensional laminate glass articles 401. The mold body 412 may comprise any metal or other material capable of withstanding high temperatures, such as refractory metals, refractory ceramics, or the like. For example, the mold body 412 may comprise a high temperature alloy with high hardness, such as, but not limited to, nickel-based alloys such as Inconel® 718 or other, similar high temperature alloys, such as graphite. In some embodiments, the mold assembly 370 may contain a coating, such as a refractory nitride coating, which may enhance the durability of the mold.

As depicted in FIG. 4, following assembly and weak-bonding of the glass sheets 110, 120, 130 to form the weakly-bonded glass stack 201, the weakly-bonded glass stack 201 may be placed on the mold body 412. The laminate glass article 301 may undergo a shaping step 405 by contacting the weakly-bonded glass stack 201 with the mold body 412 and the plunger 418. The second surface 114 may be contacted by the molding surface 414 and the plunger 418 may contact the first surface 112 to apply pressure in a direction generally orthogonal to the majority of the molding surface 414. The pressure applied by the plunger 418 may push the weakly-bonded glass stack 201 towards the mold body 412 to form a three-dimensional laminate glass article 401 having the shape provided by the mold body 412. In some embodiments, the plunger 418 and the ring 416 may contact the weakly-bonded glass stack 201 simultaneously. In other embodiments, the plunger 418 may first contact the weakly-bonded glass stack 201, followed by the ring 416 making contact with the weakly-bonded glass stack 201, or vice versa.

In some embodiments, the glass material may be pushed into the ring 416 to form rounded edges 154 on the three-dimensional laminate glass article 401. In accordance with some embodiments, the ring 416 may comprise a cavity having a recess in the shape of the three-dimensional laminate glass article 401. The ring 416 may be comprised of two concentric rings or O-ring cavities to form a semi-circular hollow into which the glass material is pushed to form the three-dimensional laminate glass article 401. The ring 416 may, in some embodiments, have a rectangular perimeter, or may have the perimeter of any shape, to produce the desired shaping for the three-dimensional laminate glass article 401. In some embodiments, the outer perimeter 152 of the laminate glass article 301 may be pushed into the ring 416 to encapsulate the second glass layer 1200 inside of the first glass layer 1100 and the third glass layer 1300. In some embodiments, the second glass sheet 120 may have a longitudinal length 176 that is shorter than the longitudinal length 172 of the first glass sheet 110 and the longitudinal length 174 of the third glass sheet 130 by a distance of about the thickness 166 of the second glass sheet 120, so that the first glass sheet 110 and the third glass sheet 130 encapsulate the second glass sheet 120 during the shaping step 405. As used herein, the term “encapsulate” refers to enveloping and substantially surrounding an object. The encapsulation may provide strength and support in the three-dimensional laminate glass article 401, such as providing support and compressive stress at the rounded edges 154 of the three-dimensional laminate glass article 401. In some embodiments, encapsulating the second glass sheet 120 in the first glass sheet 110 and the third glass sheet 130 may provide strengthened rounded edges 154, which may, in some embodiments, prevent the three-dimensional laminate glass article 401 from breaking if a rounded edge 154 is damaged.

According to another embodiment, the process depicted in FIG. 4 may be modified by utilizing a mold assembly which allows for the glass stack to sag by gravity while it is being shaped. For example, at least a portion of the central portion of the mold body 412 may be removed relative to the apparatus depicted in FIG. 4, or the entire mold body 412 may be removed. In one or more embodiments, the shaping step 405 may comprise contacting an outer perimeter 152 of the laminate glass article 301 or the weakly-bonded glass stack 201 with a ring 416 of the mold assembly 370, wherein the ring 416 comprises an upper cavity portion (as shown in FIG. 4) and additionally comprises a lower cavity portion, which may have a shape similar to the edge of the mold body 412 where the glass stack contacts the mold body 412. In some embodiments, the laminate glass article 301 or the weakly-bonded glass stack 201 may sag to form a three-dimensional shape in its interior portion. On the exterior portion, the weakly-bonded glass stack may sag into the lower cavity portion (similar to the process depicted in FIG. while the laminate glass article 301 or the weakly-bonded glass stack 201 is pressed into the upper cavity portion of the ring 416 to encapsulate the second glass sheet 120 inside a cladding comprising the first glass sheet 110 and the third glass sheet 130 to form the three-dimensional glass article 401 (similar to as depicted in FIG. 4). In some embodiments, the sagging may occur using only gravity. In embodiments, the sagging may additionally use heat. The major difference between the shaping by sagging described herein and the plunger and mold-body including process depicted in FIG. 4 is the lack of need for a plunger to press downward into a mold body when the glass can sag below where the mold body would be positioned. Gravity can shape the glass article, and the downward plunging force may not be required. Where the interior of the glass would be shaped by the molding surface 414 in the embodiment of FIG. 4, the open space left by the elimination of the central portion of the mold body 412 allows the glass to sag.

In some embodiments, any or all components of the mold assembly 370, such as the mold body 412, the molding surface 414, the ring 416, and/or the plunger 418, may be at a temperature of above room temperature (such as above about 25° C.) before coming into contact with the laminate glass article 301. The mold body 412, the molding surface 414, the ring 416, and/or the plunger 418, may be heated or allowed to heat to an increased temperature before contacting the laminate glass article 301. For thin laminate glass articles 301, such as a laminate glass article 301 with a thickness of less than or equal to 3 mm, if any component of the mold assembly 370 is at too low of a temperature, the mold assembly 370 may extract heat from the laminate glass article 301, which may increase the viscosity of the glass and may prevent the laminate glass article 301 from properly encapsulating the second glass sheet 120 within the first glass sheet 110 and the second glass sheet 120. For instance, if the viscosity of the laminate glass article 301 is too high during the shaping step 405, such as a rise in viscosity of up to about 10³ poise due to heat loss, the glass may not be fluid enough to flow and fill the entire mold, and the edges may not be pushed into the ring 416 to create the rounded edges 154. In some embodiments, one or more components of the mold assembly 370 may be heated, such as within a furnace or by directly applying heat to the mold assembly 370, any individual component of the mold assembly 370 (such as the ring 416, plunger 418, etc.) or to the laminate glass article 301.

In some embodiments, the three-dimensional laminate glass article 401, now shaped, may be separated from the mold body 412 in a separating step 406. Prior to separation from the mold body 412, the three-dimensional laminate glass article 401 may be cooled or allowed to cool to a temperature below its softening point so that it is relatively rigid and will maintain its shape. In some embodiments, the three-dimensional laminate glass article 401 may be allowed to cool to a temperature of less than about 100° C. In one embodiment, there may be little or no sticking between the mold body 412 and the three-dimensional laminate glass article 401. In some embodiments, a composition such as boron nitride may be sprayed on the mold assembly 370 to aid in the separating step 406 and prevent the laminate glass article 301 from sticking to the mold assembly 370.

In some embodiments, the first glass sheet 110 may have a lower coefficient of thermal expansion (CTE) than the second glass sheet 120. The term “CTE,” as used herein, refers to the average coefficient of linear thermal expansion of the glass composition between 0° C. and 300° C. The CTE can be determined, for example, using the procedure described in ASTM E228 “Standard Test Method for Linear Thermal Expansion of Solid Materials With a Push-Rod Dilatometer” or ISO 7991:1987 “Glass—Determination of coefficient of mean linear thermal expansion.” A glass article strengthened by lamination is formed from at least two glass compositions that have different coefficients of thermal expansion. These glass compositions are traditionally brought into contact with one another in a molten state (e.g., above their softening temperatures) to form the glass article and fuse or laminate the glass compositions together. As the glass compositions cool, the difference in the coefficients of thermal expansion may cause compressive stresses to develop in at least one of the layers of glass, thereby strengthening the glass article. Lamination processes can also be used to impart or enhance other properties of laminate glass articles, including physical, optical, and chemical properties. In some embodiments, the glass stack may be comprised of three or more glass sheets and the innermost glass layer may have a greater CTE than the outer-most glass sheets. This formation may generate compressive stress in the laminate glass article to strengthen the stack without the need for time-consuming and expensive strengthening processes such as ion exchange. In some embodiments, the first glass sheet 110, the second glass sheet 120, or both may exhibit a CTE of from about 30×10⁻⁷/° C. to about 110×10⁻⁷/° C., or from about 45×10⁻⁷/° C. to about 90×10⁻⁷/° C.

In some embodiments, the CTE of the first glass sheet 110 and/or the third glass sheet 130 and the CTE of the second glass sheet 120 differ by at least about 1×10⁻⁷/° C., at least about 2×10⁻⁷/° C., at least about 3×10⁻⁷/° C., at least about 4×10⁻⁷/° C., at least about 5×10⁻⁷/° C., at least about 10×10⁻⁷/° C., at least about 15×10⁻⁷/° C., at least about 20×10⁻⁷/° C., at least about 25×10⁻⁷/° C., at least about 30×10⁻⁷/° C., at least about 35×10⁻⁷/° C., at least about 40×10⁻⁷/° C., or at least about 45×10⁻⁷/° C. Additionally, or alternatively, the CTE of the first glass sheet 110 and/or the third glass sheet 130 and the CTE of the second glass sheet 120 differ by at most about 100×10⁻⁷/° C., at most about 75×10⁻⁷/° C., at most about 50×10⁻⁷/° C., at most about 40×10⁻⁷/° C., at most about 30×10⁻⁷/° C., at most about 20×10⁻⁷/° C., at most about 10×10⁻⁷/° C., at most about 9×10-/° C., at most about 8×10⁻⁷/° C., at most about 7×10⁻⁷/° C., at most about 6×10⁻⁷/° C., or at most about 5×10⁻⁷/° C. For example, in some embodiments, the CTE of the first glass sheet 110 and/or the third glass sheet 130 and the CTE of the second glass sheet 120 differ by about 1×10⁻⁷/° C. to about 10×10⁻⁷/° C. or about 1×10⁻⁷/° C. to about 5×10⁻⁷/° C. In some embodiments, the first glass sheet 110 and/or the third glass sheet 130 comprise a CTE of at most about 90×10⁻⁷/° C., at most about 89×10⁻⁷/° C., at most about 88×10⁻⁷/° C., at most about 80×10⁻⁷/° C., at most about 70×10⁻⁷/° C., at most about 60×10⁻⁷/° C., at most about 50×10⁻⁷/° C., at most about 40×10⁻⁷/° C., or at most about 35×10⁻⁷/° C. Additionally, or alternatively, the first glass sheet 110 and/or the third glass sheet 130 comprise a CTE of at least about 10×10⁻⁷/° C., at least about 15×10⁻⁷/° C., at least about 25×10⁻⁷/° C., at least about 30×10⁻⁷/° C., at least about 40×10⁻⁷/° C., at least about 50×10⁻⁷/° C., at least about 60×10⁻⁷/° C., at least about 70×10⁻⁷/° C., at least about 80×10⁻⁷/° C., or at least about 85×10⁻⁷/° C. Additionally, or alternatively, the second glass sheet 120 comprises a CTE of at least about 40×10⁻⁷/° C., at least about 50×10⁻⁷/° C., at least about 55×10⁻⁷/° C., at least about 65×10⁻⁷/° C., at least about 70×10⁻⁷/° C., at least about 80×10⁻⁷/° C., or at least about 90×10⁻⁷/° C. Additionally, or alternatively, the second glass sheet 120 comprises a CTE of at most about 120×10⁻⁷/° C., at most about 110×10⁻⁷/° C., at most about 100×10⁻⁷/° C., at most about 90×10⁻⁷/° C., at most about 75×10⁻⁷/° C., or at most about 70×10⁻⁷/° C.

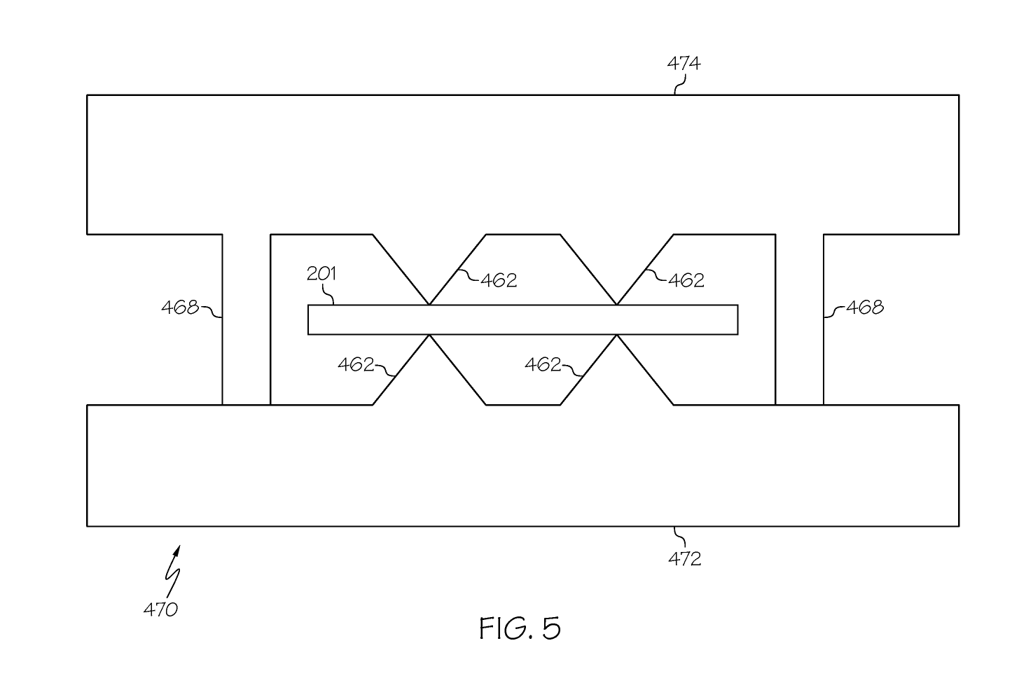

Now referring to FIG. 5, in some embodiments, the glass sheet may be resized and/or reshaped by a shearing assembly 470 comprising at least one angled jaw 462 to shape the weakly-bonded glass stack 201. While FIG. 5 depicts a weakly-bonded glass stack 201, it should be understood that the laminate glass article 301 may be used in the shearing assembly 470 as well. The shearing assembly 470 may comprise a top portion 474 and a bottom portion 472 opposite the top portion 474. In some embodiments, the weakly-bonded glass stack 201 is positioned between the top portion 474 and the bottom portion 472 of the shearing assembly 470. Alignment pins 468 may allow for coordinated movement between the top portion 474 and the bottom portion 472 such that they move closer to one another, contacting the glass, when shearing commences. The top portion 474 and/or the bottom portion 472 may press against the weakly bonded glass stack 201 under heat in a direction generally orthogonal to the length of the glass sheets. In some embodiments, the weakly-bonded glass stack 201 may be fused at the second temperature range while the angled jaws 462 move towards each other to pinch the laminate glass article 301 to a thinness that would allow for separation in a shearing motion. The angled jaws 462 may be used to shear or cut the weakly-bonded glass stack 201 to encapsulate a core glass layer, comprising the second glass sheet 120, within the cladding glass layer, comprising the first glass sheet 110 and the third glass sheet 130, during fusing of the weakly-bonded glass stack 201.

In some embodiments, the shearing motion may pull a cladding layer comprised of the first glass sheet 110 and the third glass sheet 130, over a core layer comprised of the second glass sheet 120 to create a strong, rounded edge, similar to edge 154 depicted in FIG. 4. In some embodiments, the angled jaws 462 may allow for easy, cost-efficient strengthening of the edges 154 of the three-dimensional laminate glass article 401, which may not require grinding, etching, and/or polishing of the edges 154. In some embodiments, the three-dimensional laminate glass article 401 may be shaped and cut during the shaping step 405, depicted in FIG. 4. In some embodiments, the shearing or cutting step may occur offline. Some embodiments may utilize any number of angled jaws 462, such as one angled jaw 462, two angled jaws 462, four angled jaws 462, eight angled jaws 462, or any number of angled jaws 462 to shape the laminate glass article 301.

The angled jaws 462 may comprise stainless steel and may comprise alignment pins 468 at each corner of the shearing assembly 470 to ensure consistent alignment during formation. The angled jaws 462, the shearing assembly 470, and the alignment pins 468 all may comprise stainless steel. In some embodiments, the laminate glass article 301 or the weakly-bonded glass stack 201 may be cut into squares or another shape, such as a disk, and placed on the shearing assembly 470 such that the laminate glass article 301 or the weakly-bonded glass stack 201 does not make contact with the alignment pins 468. In some embodiments, the angled jaws 462 may be triangles, for instance, isosceles triangles, and may, in some embodiments, have an angle of approximately 60-650, such as a 64° angle. In other embodiments, the angled jaws 462 may be triangular and may exhibit an angle of approximately 62-66°, or 55-60°, or 50-55°, or 65-70°, or even 70-75°. In some embodiments, the angled jaws 462 and/or the shearing assembly 470 may be heated before contacting the laminate glass article 301, such as heating the angled jaws 462 and shearing assembly 470 in an isothermal furnace.

In some embodiments, boron nitride or other suitable compositions may be sprayed on the angled jaws 462, the shearing assembly 470, or both before contacting the angled jaws 462 with the laminate glass article 301 or the weakly-bonded glass stack 201 to prevent the glass from sticking to the metal. In some embodiments, the shaping 405 of the laminate glass article 301 or the weakly-bonded glass stack 201 may comprise placing the laminate glass article 301 or the weakly-bonded glass stack 201 near the one or more angled jaws 462. In some embodiments, the angled jaws 462, the shearing assembly 470, and the laminate glass article 301 or the weakly-bonded glass stack 201 may be placed in a furnace, such as an isothermal programmable furnace. The weakly-bonded glass stack 201 may be fused and sheared while in the furnace, or, in some embodiments, may be removed and then sheared. The angled jaws 462, shearing assembly 470 and laminate glass article 301 or weakly-bonded glass stack 201 may be placed in the furnace at a temperature of about 800° C. to 1000° C., such as a temperature of about 900° C., or at a temperature of about 1000° C. to 1200° C., or a temperature of about 600° C. to 800° C. In some embodiments, the temperature may be increased over time, such as an increase of 10° C./minute, 5° C./minute, 1° C./minute, or 20° C./minute, (such as from 1° C./minute to 20° C. per minute) or until the desired temperature is reached. In some embodiments, the temperature may be held for a period of time of about 15 minutes, about 20 minutes, about 10 minutes, or about 5 minutes (such as from 5 minutes to 20 minutes).

In some embodiments, shearing the laminate glass article 301 or the weakly-bonded glass stack 201 with the angled jaws may form encapsulated, rounded edges 154 in the three-dimensional laminate glass article 401. In some embodiments, the three-dimensional laminate glass article 401 may be annealed at temperature of about 600° C. to about 650° C., such as a temperature of about 640° C., or 630° C., or 620° C. In some embodiments, the three-dimensional laminate glass article 401 may be annealed for about 15-45 minutes, such as for about 25 minutes, about 30 minutes, or about 35 minutes. In other embodiments, the three-dimensional laminate glass article 401 may be annealed for about an hour or about two hours (such as from about 30 minutes to about 3 hours). After annealing, in some embodiments, the three-dimensional laminate glass article 401 may be cooled to room temperature. As a final optional finishing step, the rounded edges 154 may be fire polished in some embodiments.

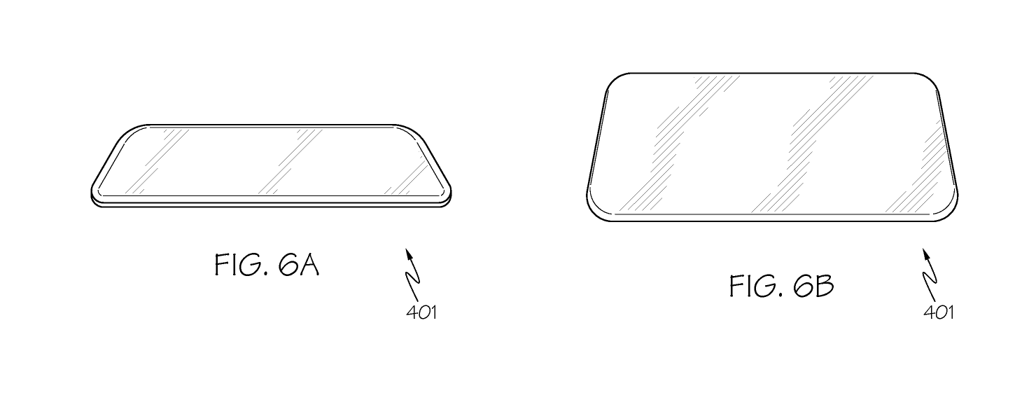

FIGS. 6A and 6B depict different views of an example three-dimensional laminate glass article 401 which may be manufactured according to one or more embodiments shown and described herein. The three-dimensional laminate glass article 401 may, in some embodiments, be an electronic device part, an automotive part, or a portion of a medical device. In some embodiments, the three-dimensional laminate glass article 401 may be strengthened due to compressive stress. In some embodiments, the three-dimensional laminate glass article 401 may have reinforced, strengthened edges 154 as depicted in FIG. 4. The three-dimensional laminate glass article 401 may, in some embodiments, be incorporated into a cell phone display, a television display, or other glass parts for electronic devices. In other embodiments, the three-dimensional laminate glass article 401 may be a headlamp cover, an automotive windows, a shaped strengthened parts for automotive interiors, a glass container for medical purposes, a vial, a syringe, a lunch box container, or other laminate glass items. The three-dimensional laminate glass articles 401 may, in some embodiments, be hollow ware, such as cups and containers, dinnerware such as plates and bowls, or may include larger kitchen items such as sinks.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for manufacturing a three-dimensional laminate glass article, the method comprising:
heating a glass stack comprising at least a first glass sheet and a second glass sheet that are unbonded at a first temperature range of about 150° C. to about 400° C. for a first period of time of at least about 5 minutes;
fusing the first glass sheet with the second glass sheet by heating the glass stack at a second temperature range of about 400° C. to about 1200° C.; and
shaping the glass stack during or after the fusing to form the three-dimensional laminate glass article.

2. The method of claim 1, wherein the heating the glass stack at the first temperature range forms a hydrogen-bonded glass stack comprising the first glass sheet hydrogen-bonded to the second glass sheet.

3. The method of claim 1, wherein the first glass sheet and the second glass sheet are in direct contact with one another.

4. The method of claim 1, wherein the heating the glass stack at the first temperature range occurs prior to the fusing the first glass sheet with the second glass sheet.

5. The method of claim 1, wherein the shaping the glass stack occurs while the glass stack is heated at the second temperature range.

6. The method of claim 1, further comprising cooling the glass stack to a temperature of less than about 100° C. following the fusing and prior to the shaping.

7. The method of claim 1, wherein the first glass sheet comprises a first coefficient of thermal expansion (CTE) from about 30×10⁻⁷/° C. to about 60×10⁻⁷/° C. and the second glass sheet comprises a second CTE from about 45×10⁻⁷/° C. to about 110×10⁻⁷/° C., and wherein the second CTE is greater than the first CTE.

8. The method of claim 1, wherein the glass stack comprises a third glass sheet and the second glass sheet is positioned between and in contact with each of the first glass sheet and the third glass sheet.

9. The method of claim 8, wherein the first glass sheet comprises a first coefficient of thermal expansion (CTE), the second glass sheet comprises a second CTE, and the third glass sheet comprises a third CTE, wherein the second CTE is greater than the first CTE and the third CTE.

10. The method of claim 9, wherein each of the first CTE and the third CTE is about 30×10⁻⁷/° C. to about 60×10⁻⁷/° C., and the second CTE is about 45×10⁻⁷/° C. to about 110×10⁻⁷/° C.

11. The method of claim 8, wherein the shaping encapsulates the second glass sheet inside a cladding comprising the first glass sheet and the third glass sheet.

12. The method of claim 8, wherein the shaping comprises:
contacting an outer perimeter of the glass stack with a ring of a mold assembly;
allowing at least a portion of the glass stack to sag to form a three-dimensional shape; and
encapsulating the second glass sheet inside a cladding comprising the first glass sheet and the third glass sheet with the ring.

13. The method of claim 8, wherein the shaping comprises:
contacting a first outer surface of the glass stack with a mold body of a mold assembly;
contacting a second outer surface of the glass stack opposite the first outer surface with a plunger of the mold assembly in a direction generally orthogonal to a molding surface of the mold assembly; and
pushing an outer perimeter of the glass stack into a ring of the mold assembly to encapsulate the second glass sheet inside the cladding comprising the first glass sheet and the third glass sheet.

14. The method of claim 8, further comprising encapsulating the second glass sheet inside the cladding comprising the first glass sheet and the third glass sheet by contacting the glass sheet with angled jaws that press into the glass stack.

15. The method of claim 14, wherein the angled jaws are triangular in shape.

16. The method of claim 1, wherein of the first temperature range is about 200° C. to about 350° C.

17. The method of claim 1, wherein the first period of time is about 5 minutes to about 3 hours.

18. The method of claim 1, further comprising cleaning the first glass sheet, the second glass sheet, or both prior to the heating to the first temperature range.

19. A method for manufacturing a three-dimensional laminate glass article, the method comprising:
heating a glass stack at a first temperature range of about 150° C. to about 400° C. for a first period of time of at least about 5 minutes, the glass stack comprising a first glass sheet, a second glass sheet, and a third glass sheet, the second glass sheet positioned between the first glass sheet and the third glass sheet, the first glass sheet having a first coefficient of thermal expansion (CTE) and a first viscosity, the second glass sheet having a second CTE and a second viscosity, and the third glass sheet having a third CTE and a third viscosity, the second CTE greater than the first CTE and the third CTE, and the second viscosity less than the first viscosity and the third viscosity;
fusing the first glass sheet with the second glass sheet by heating the glass stack at a second temperature range of about 400° C. to about 1200° C.; and
shaping the glass stack to form the three-dimensional laminate glass article, wherein the shaping encapsulates the second glass sheet inside a cladding comprising the first glass sheet and the third glass sheet.

20. The method of claim 19, wherein shaping the glass stack occurs while the glass stack is heated at the second temperature range.
